(19) United States
(12) Patent Application Publication
(10) Pub. No.: US 2010/0221168 A1
(43) Pub. Date: Sep. 2, 2010

(54) Cryogenic system for neon production

(76) Inventor: Joseph Theodore Bernstein, Weston, CT (US)

Correspondence Address: Joseph T. Bernstein, 115 Kettle Creek Road, Weston, CT, 06883, US

(21) Appl. No.: 12/660,563

(22) Filed: Mar. 1, 2010

Related U.S. Application Data
(60) Provisional application No. 61/209,011, filed on Mar. 2, 2009.
(60) Provisional application No. 61/216,879, filed on May 23, 2009.

(51) Int. Cl. C01B 23/00

(52) U.S. Cl. 423/262

(57) ABSTRACT

A method and apparatus for the recovery of crude neon in or as part of a cryogenic air separation system wherein a neon recovery tower recovers crude neon from a nitrogen product stream originating from the top of the high pressure tower, and wherein the cooling for condensing in the neon recovery tower is provided by evaporating the liquefied nitrogen product from the bottom of the neon tower after the nitrogen liquid passes through a pressure reducing valve.

### CROSS-REFERENCE TO RELATED APPLICATIONS

This application claims the benefit of provisional patent application No. 61/209,011 filed 2009 Mar. 2 by the present inventor and claims the benefit of provisional patent application No. 61/216,879 filed 2009 May 23 by the present inventor.

### FEDERALLY SPONSORED RESEARCH

Not applicable.

### SEQUENCE LISTING

Not applicable.

### BACKGROUND

1. Field of Invention

This invention relates to a cryogenic process for recovering crude neon in a double tower cryogenic air separation plant.

2. Prior Art

As used herein the term “column” means a distillation or fractionation column, i.e., a contacting column wherein liquid and vapor phases are countercurrently contacted to effect separation of a fluid mixture by contacting of the vapor and liquid phases on a series of vertically spaced trays or plates mounted within the column or on packing elements such as structured or random packing.

As used herein the term “high-pressure tower” means the tower in the cryogenic air separation double tower system which operates at the higher pressure, usually in the range of about 5-6 ATMA. As used herein the term “low pressure tower” means the tower in the cryogenic air separation double tower system which operates at a lower pressure, usually about 1.2-1.6 ATMA.

As used herein the term “heat exchanger” is a device for effecting indirect heat exchange by bringing two fluids into heat exchange relation without any physical contact or intermixing of the fluids with each other.

As used herein the terms “reboiler” means a heat exchanger device that generates vapor from liquid.

As used herein the term “condenser” means a heat exchange device that generates column liquid from vapor.

As used herein the term “reboiler-condenser” means a device that simultaneously performs functions of a reboiler and condenser.

In the typical cryogenic air separation process described, an expander is a device which produces refrigeration by extracting work from a fluid while lowering the fluid pressure and simultaneously reducing the temperature of the expanded fluid.

The recovery of crude neon in cryogenic air separation plants is well known and has been widely practiced. The book “Cryogenic Systems” by Randall Barron (published in 1966 by McGraw-Hill) on pages 248-249 and in FIG. 4-38 describes a conventional “neon-recovery subsystem” where nitrogen-rich gas leaving the condenser at the top of the high pressure tower in a typical double tower air separation system enters a crude neon tower. Condensing refrigeration in the neon tower is provided by liquid nitrogen taken from the top of the high pressure tower, which is reduced in pressure and the evaporated nitrogen vapor joins the nitrogen product leaving that top of the upper (or low pressure) section of the double tower system. A similar description of neon recovery in connection with a typical cryogenic air separation system double tower is given in the book “Separation of Gases” by W H Isalski on pages number 100-101 (published by Clarendon Press-Oxford, 1989).

This invention relates to the recovery and production of crude neon in connection with a cryogenic air separation plant which produces oxygen and/or nitrogen from ambient air, utilizing a double tower distillation system. The double tower distillation system is the most common system used in the cryogenic separation of air to produce oxygen and/or nitrogen, and is described in the book “Cryogenic Systems” by Randall Barron (published in 1966 by McGraw-Hill) on pages 236-239 and in FIG. 4-32.

Some of the significant features of the prior art relating to Neon recovery cryogenic air separation plants (as, for instance, shown in FIG. 4-38 and the accompanying description in “Cryogenic Systems”, by Randall Barron, published in 1966 by McGraw-Hill), as contrasted to the present invention include:

1.) Nitrogen vapor from the top of the high-pressure Tower enters the Neon condenser-rectifier, and the condensed nitrogen is returned to the top of the high-pressure Tower.
1A.) In this invention, the nitrogen vapor from the top of the high-pressure Tower which enters the crude neon recovery tower is evaporated at a slightly lower pressure, and the nitrogen vapor does not return to the high-pressure Tower, but leaves the ASU system as Nitrogen vapor product.
2.) In the above referenced prior art example, liquid nitrogen evaporated in the crude neon condenser-rectifier is evaporated at low-pressure Tower pressure.
2A.) In the present invention, liquid nitrogen evaporated in the crude neon condenser-rectifier is evaporated at an elevated pressure, substantially above the low-pressure Tower pressure and close to the high-pressure Tower pressure.
3.) In the above referenced prior art example, nitrogen which is condensed in the neon condenser-rectifier does not provide reboiling at the bottom of the low-pressure Tower, and because of the reduction in low-pressure Tower reboiling, the recovery of Oxygen in the low-pressure Tower is reduced.
3A.) In the present invention, the nitrogen vapor which goes to the neon condenser-rectifier is intermediate (high-pressure Tower) pressure nitrogen vapor product, and no additional nitrogen vapor is withdrawn from the high-pressure Tower, so the reboiling and oxygen recovery in the low-pressure Tower is not affected.

### ADVANTAGES

An advantage of this invention is that, in a cryogenic air separation double tower system producing vapor nitrogen product from the top of the high-pressure tower, no liquid nitrogen is required from the double tower system. The use of liquid nitrogen from the double tower system in the neon tower condenser removes liquid nitrogen which would otherwise be used as reflux in the double tower system, and/or reduces the reboiling in the double tower low-pressure tower, thus reducing the separation or recovery of oxygen and/or nitrogen in the cryogenic air separation double tower system. In the improved method and apparatus of this invention, the nitrogen product “self-condenses” in the crude neon tower, without any effect on the flows or recovery in the cryogenic air separation double tower system. An important aspect of the invention is that the only connection between the crude neon tower and the typical cryogenic air separation double tower is the nitrogen product stream leaving the top of the high-pressure tower or leaving the high pressure tower condenser, and there is no other connection between the crude neon tower and the double tower system. The use or addition of the crude neon recovery tower therefore has no effect on the operation of the double tower system.

Another advantage of this invention is that the product and nitrogen stream originating at the top of the high-pressure tower is only partly reduced in pressure in the crude neon recovery tower, and is available as a nitrogen vapor product at an intermediate pressure, higher than the low pressure, but partly reduced below the high-pressure column pressure.

In summary, the main elements of this invention which distinguish it from prior art and which are its advantages relative to prior art include:
A.) The crude neon tower is “self-condensing” and does not require withdrawal of liquid nitrogen from the cryogenic air separation double tower system. Such withdrawal of liquid nitrogen can degrade the separation performance of the double tower distillation system.
B.) The nitrogen product from the top of the high-pressure tower, which is directed to the crude neon recovery distillation tower, is only partly reduced in pressure to provide condensing refrigeration in the crude neon tower. It is not, as in some prior art, reduced to the pressure of the low pressure distillation column, to be delivered as a product at near atmospheric pressure. In this invention, the product nitrogen stream is partly reduced from the pressure of the high-pressure distillation tower by approximately 5-25 PSI, and is available as a nitrogen vapor product at an intermediate pressure, higher than the low pressure column pressure but partly reduced below the high-pressure column pressure.
C.) Other than that nitrogen product stream originating at the top of the high-pressure distillation column, which is the feed stream to the crude neon recovery distillation column, there is no connection of streams to or from the crude neon tower and the double tower distillation system. Because of this lack of connection, the function and operation of the crude neon tower does not have any effect on the normal operation of the double tower distillation system.

### SUMMARY

This invention is applicable to the recovery of crude neon in a cryogenic air separation double tower system, where a nitrogen vapor product is produced, or is desired to be produced, originating from the top of the lower or high pressure tower or from the vapor entering or leaving the condenser of the high pressure tower. The nitrogen vapor product from the high pressure tower enters the bottom of the neon recovery tower and is enriched in neon as it flows to the top of the neon tower. The nitrogen condensed in the neon tower condenser flows to the bottom of the neon recovery tower, where it is removed from the neon tower bottom, passes through a pressure reducing valve and enters the cold side of the neon tower condenser, and is evaporated to provide condensing refrigeration in the neon tower. The evaporated nitrogen is then warmed in the air separation plant main heat exchanger or other heat exchanger to become nitrogen vapor product. The crude neon product, comprising a small fraction [approximately 0.033%] of the air entering the double tower system, can be warmed and produced as crude neon product, or can enter a second stage neon purification tower which may produce a higher purity crude neon product.

### DRAWINGS

### Figures

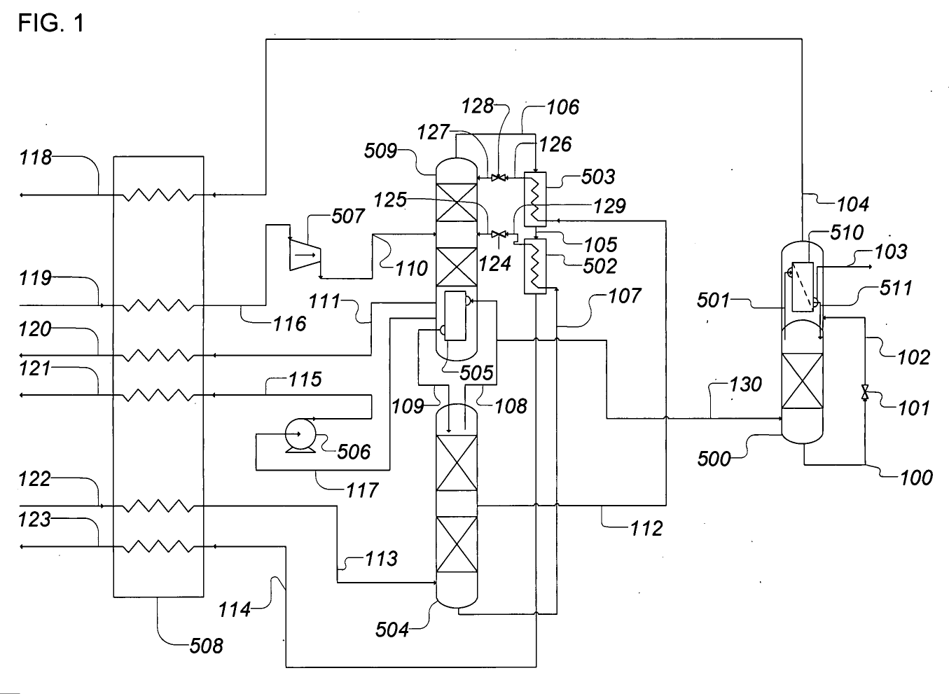

FIG. 1 is the neon recovery process in a typical double tower cryogenic air separation system.

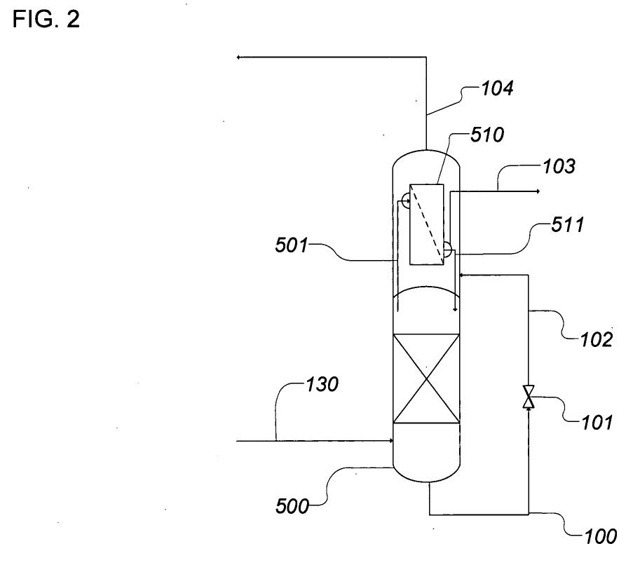

FIG. 2 is the primary crude neon tower.

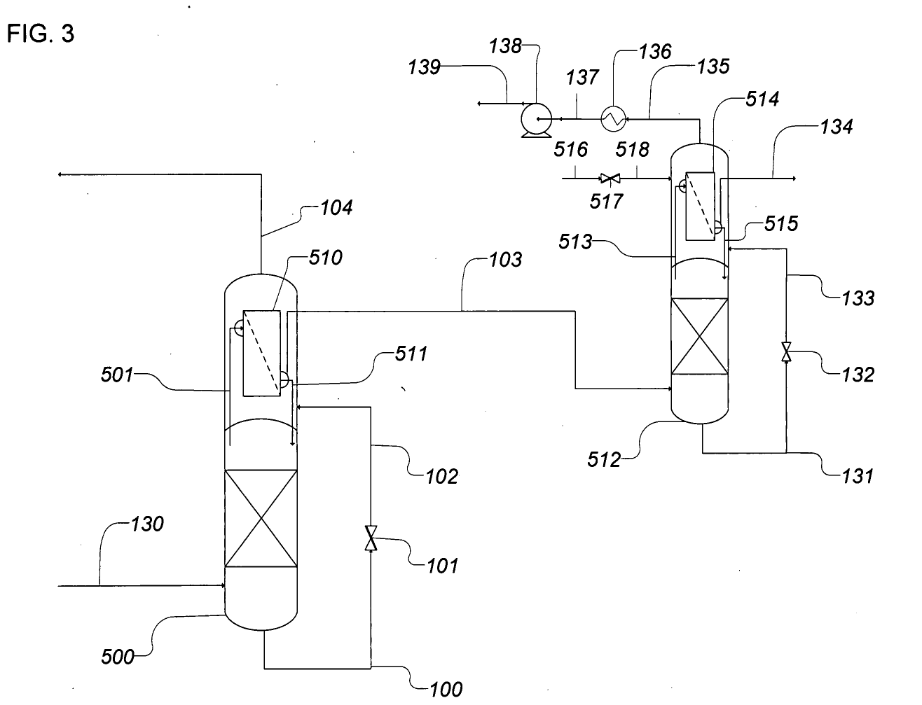

FIG. 3 is the primary and second stage neon towers.

### REFERENCE NUMERALS

Drawing Reference Numerals

| Part No. | Part Name |
|---|---|
| | Stream, N2 Liquid |
| 101 | Valve |
| 102 | Stream, N2 Liquid and Vapor |
| 103 | Stream, Crude Neon Product |
| 104 | Stream, N2, Evaporated |
| 105 | Stream, N2 Enriched |
| 106 | Stream, N2 Enriched Vapor Product |
| 107 | Stream, O2 Enriched |
| 108 | Stream, N2 Enriched |
| 109 | Stream, N2 Reflux |
| 110 | Stream, Air |
| 111 | Stream, O2 Enriched |
| 112 | Stream, N2 Enriched |
| 113 | Stream, Air |
| 114 | Stream, N2 Enriched |
| 115 | Stream, O2 Product |
| 116 | Stream, Air |
| 117 | Stream, O2 Liquid Product |
| 118 | Stream, N2 Vapor Product |
| 119 | Stream, Air |
| 120 | Stream, O2 Vapor Product |
| 121 | Stream, O2 Product |
| 122 | Stream, Air |
| 123 | Stream, N2 Enriched Product |
| 124 | Valve |
| 125 | Stream, O2 Enriched, Pressure-Reduced |
| 126 | Stream, N2 Liquid |
| 127 | Stream, N2 Reflux |
| 128 | Valve |
| 129 | Stream, O2 Enriched, Cooled |
| 130 | Stream, N2 Vapor Product |
| 131 | Stream, N2 |
| 132 | Valve |
| 133 | Stream, N2 |
| 134 | Stream, Enriched Neon Product |
| 135 | Stream, N2 Vapor |
| 136 | Heat Exchanger |
| 137 | Stream, N2 |
| 138 | Vacuum Pump |
| 139 | Stream, Exhaust |
| 500 | Neon Recovery Tower |
| 501 | Stream, N2 Vapor |
| 502 | Heat Exchanger (subcooler) |
| 503 | Second Heat Exchanger (subcooler) |
| 504 | High Pressure Distillation Tower |
| 505 | Reboiler-Condenser |
| 506 | Liquid Oxygen Pump |
| 507 | Air Expander |
| 508 | Main Heat Exchanger |
| 509 | Low Pressure Distillation Tower |
| 510 | Neon Tower (condenser) |
| 511 | Stream, N2 Liquid |
| 512 | Second Stage Recovery Tower |
| 513 | Stream, N2 Vapor |
| 514 | Neon Tower (condenser) |
| 515 | Stream, N2 Liquid |
| 516 | Stream, Supplemental N2 Liquid |
| 517 | Valve |
| 518 | Stream, N2 Liquid |

### DETAILED DESCRIPTION

### FIGS. 1 and 2

### First Embodiment

FIG. 1 is a simplified schematic representation of one embodiment of the cryogenic rectification system of this invention for recovery of crude neon in a cryogenic air separation double tower system, where a nitrogen vapor product is produced, or is desired to be produced, originating from the top of the lower or high pressure tower or from the vapor entering or leaving the condenser of the high pressure tower. Referring to FIG. 1, typical components of a cryogenic air separation system utilizing a double tower are shown, including a main heat exchanger 508 for heat exchange between air feed and products; and further showing a high pressure distillation tower 504, and low pressure distillation tower 509, including reboiler-condenser 505. An air expander 507 to produce low-temperature refrigeration is shown and a liquid oxygen pump 506 is also shown. Heat exchanger 502 and heat exchanger 503 are subcoolers associated with the double tower cryogenic air separation system. It is understood that these components of a “typical cryogenic air separation system” utilizing a double tower distillation system are subject to considerable variation in detail, and may include fewer or more components in the cryogenic air separation system utilizing the double tower distillation process.

### Operation

### FIGS. 1 and 2

### First Embodiment

In FIG. 1, ambient air, compressed to a pressure above the high-pressure tower pressure and after pre-purification to remove condensable components such as carbon dioxide and moisture, enters the feed-product main heat exchanger 508 as stream 122, and after cooling leaves as stream 113, and enters the bottom of the high pressure tower 504. An additional air feed stream 119 may also enter the main heat exchanger 508 and after cooling leave the main heat exchanger 508 as stream 116, which enters the expander 507 and after reduction in temperature leaves the expander as stream 110, which enters the low pressure tower 509. From the top of the high-pressure tower 504, a nitrogen-rich stream 108 enters the reboiler-condenser 505, and is condensed to form stream 109 which provides liquid reflux at the top of the high-pressure tower 504. A nitrogen vapor product stream 130 is withdrawn from the vapor stream 108 leaving the top of the high-pressure tower and entering the reboiler-condenser. Alternately, the nitrogen vapor product stream 130 can be withdrawn as uncondensed vapor at the exit of the reboiler-condenser 505. In addition to the nitrogen vapor product stream 130, a liquid nitrogen-rich stream 112 is withdrawn from the high-pressure tower at a point intermediate between the top tray or top of the packing section and the bottom tray or bottom of the packing section in the high-pressure tower. The liquid nitrogen stream 112 is sub-cooled in subcooler heat exchanger 503 to form stream 126, which is reduced in pressure in valve 128 and enters the top of the low pressure tower 509 as stream 127 to provide reflux liquid at the top of the low pressure tower 509. A liquid stream, enriched in oxygen relative to the air feed, stream 107 is withdrawn from the bottom of the high-pressure tower 504 and cooled in heat exchanger 502 to become stream 129, which is reduced in pressure in valve 124 to become stream 125, which is sent to an intermediate level in the low pressure tower 509.

The product streams from the low pressure tower 509 can include an oxygen-rich product, stream 111 originating at the bottom of the low pressure tower and warmed in the feed-product heat exchanger 508 to form an oxygen vapor product stream 120. Additionally or alternatively, a liquid product stream 117 can be withdrawn from the bottom of the low-pressure tower. In FIG. 1 an oxygen-rich liquid stream 117 is shown to enter pump 506 which produces a liquid stream elevated in pressure, stream 115, which can be warmed in the feed-product main heat exchanger 508 to form higher pressure oxygen product stream 121. Another product from the low pressure tower is a vapor nitrogen-rich product stream 106, which leaves the top of the low pressure tower and is warmed in the heat exchanger 503 to form stream 105 and further warmed in heat exchanger 502 to form stream 114, which in turn is warmed in the feed-product main heat exchanger 508 to form a nitrogen-rich product stream 123.

The nitrogen vapor product stream 130, from the top of the high-pressure distillation tower 504, enters the bottom of the neon recovery tower 500 and is enriched in neon as it flows to the top of the neon tower. The nitrogen vapor stream 501, leaving the top of the distillation tray or packing section of the neon recovery tower 500, is condensed in the neon tower condenser 510 to form the liquid stream 511, which returns to the top of the distillation tray or packing section and flows to the bottom of the neon recovery tower 500, where it is removed from the neon tower bottom as stream 100, passes through a pressure reducing valve 101 and, as stream 102, enters the cold side of the neon tower condenser 510, and is evaporated to provide condensing refrigeration in the neon tower. The evaporated nitrogen, stream 104, is then warmed in the air separation plant main heat exchanger 508 or other heat exchanger to become nitrogen vapor product, stream 118. The crude neon product is stream 103, the un-condensed vapor exiting the condenser 510. The crude neon product, stream 130 is a small fraction [approximately 0.033%] of the air entering the double tower system, and can be warmed and produced as crude neon product, or can first enter a second stage neon purification tower (as shown in FIG. 3) which may produce a higher purity crude neon product.

An important advantage of the invention is that the nitrogen evaporated in the neon tower condenser 510 is only partially reduced in pressure and is not reduced to the pressure level of the upper or low-pressure tower. Depending on the nitrogen product requirements, the pressure reduction of the nitrogen product in valve 101 may be in the range of 5-25 PSIA.

FIG. 2 shows the crude neon tower portion only. In the embodiment of this invention, referring to FIG. 2, the neon tower feed stream 130 is a nitrogen product stream originating from the top of the high-pressure tower in a cryogenic air separation double tower system, either as a vapor from the topmost stage or as a portion of the vapor entering or leaving the high-pressure tower condenser. In the embodiment of this invention, the product streams from the neon tower, nitrogen vapor product stream 104 and crude neon product stream 103, have no connection to the double tower system and are warmed in appropriate heat exchangers to be delivered as products, except that the crude neon product may optionally be directed to a second stage neon enrichment tower, as shown in FIG. 3.

In FIG. 2, the nitrogen vapor product, stream 130, from the top of the high-pressure distillation tower enters the bottom of the neon recovery tower 500 and is enriched in neon as it flows to the top of the neon tower. The nitrogen vapor stream 501, leaving the top of the distillation tray or packing section of the neon recovery tower 500, is condensed in the neon tower condenser 510 to form the liquid stream 511, which returns to the top of the distillation tray or packing section and flows to the bottom of the neon recovery tower 500, where it is removed from the neon tower bottom as stream 100, passes through a pressure reducing valve 101, and enters the cold side of the neon tower condenser 510 as stream 102, then is evaporated to provide condensing refrigeration in the neon tower condenser 510. The evaporated nitrogen, stream 104, is then warmed in the air separation plant main heat exchanger or other heat exchanger to become nitrogen vapor product. The crude neon product is stream 103, the un-condensed vapor exiting the condenser 510. The crude neon product, stream 130, is a small fraction [approximately 0.033%] of the air entering the double tower system, and can be warmed and produced as crude neon product, or can first enter a second stage neon purification tower (as shown in FIG. 3) which may produce a higher purity crude neon product.

A computer simulation of the embodiment of the invention illustrated in FIG. 2 was carried out and the results are presented in Table 1, below. These results are presented for illustrative purposes and are not intended to be limiting. The stream numbers correspond to those of FIG. 1 and FIG. 2.

TABLE 1

| | N2 Vapor | | N2 Vapor | |
|---|---|---|---|---|
| | Product | N2 Liquid | Product from | |
| | Feed to | Leaving Neon | Neon Tower | Crude Neon |
| | Neon Tower | Tower Bottom | Condenser | Product |
| | (Stream 130) | (Stream 100) | (Stream 104) | (Stream 103) |
| Flow, MSCFH | 225.016 | 224.817 | 224.817 | 2.957 |
| Pressure, PSIA | 79.196 | 79.196 | 69.196 | 78.70 |
| Temperature, ° F. | −288.36 | −288.36 | −291.44 | −290.49 |
| O2, Mole Fraction, % | 0.0012238 | 0.0012249 | 0.0012249 | 0.0000194 |
| N2, Mole Fraction, % | 99.9152 | 99.9969 | 99.9969 | 92.7967 |
| Ar, Mole Fraction, % | 0.0004915 | 0.0004919 | 0.0004919 | 0.0000173 |
| Ne, Mole Fraction, % | 0.06272 | 0.00128 | 0.0012782 | 5.6281129 |
| H2, Mole Fraction, % | 1.72987E−03 | 3.35827E−05 | 3.35827E−05 | 0.1477826 |
| Helium, Mole Fraction, % | 1.85895E−02 | 6.01340E−05 | 6.01340E−05 | 1.4273668 |

### Detailed Description

### FIG. 3

### Second Embodiment

FIG. 3 shows an optional embodiment of the invention in which the crude neon product from neon recovery tower 500, stream 103, is directed to a second stage neon enrichment tower in which the condenser is cooled by liquid nitrogen evaporating at a pressure below atmospheric pressure. The nitrogen vapor stream 513, leaving the top of the distillation tray or packing section of the second neon recovery tower 512, is condensed in the neon tower condenser 514 to form the liquid stream 515, which returns to the top of the distillation tray or packing section and flows to the bottom of the neon recovery tower 512, where it is removed from the neon tower bottom as stream 131. An uncondensed portion of the stream leaving condenser 514 is the enriched product neon stream 134.

### Operation

### FIG. 3

### Second Embodiment

In the second stage neon enrichment tower 512 the liquid nitrogen at the bottom of neon enrichment tower 512, stream 131, is reduced in pressure in valve 132 so that the resulting stream 133 is at a pressure below atmospheric pressure and the resulting vapor stream 135, resulting from the evaporation of the liquid nitrogen in the cold side of neon tower condenser 514, is directed to a vacuum pump 138 or other means of maintaining stream 135 at a pressure level below atmospheric pressure. In FIG. 3, the vapor nitrogen stream 135, evaporated from the second stage neon tower condenser 514, is warmed in heat exchanger 136, and the resulting stream 137 is maintained at a suitable pressure below atmospheric pressure by vacuum pump 138 and the resulting stream 139 is exhausted to the atmosphere. In the operation of the second stage neon enrichment tower 512, a supplemental liquid nitrogen stream 516 may be supplied through the valve 517 to provide an additional liquid nitrogen stream 518 to the cold side of the second stage neon tower condenser. Again, none of these streams resulting from the first and second stage neon enrichment towers in FIG. 3 has any further connection to the double tower system, except for the connection through the nitrogen product feed stream 130 entering the first stage neon recovery tower 500.

The invention claimed is:

1. A method for producing crude neon comprising:
a. Separating feed air in a high-pressure tower of a double tower cryogenic air separation system to produce a nitrogen vapor product originating at the top of the high-pressure tower or at the high-pressure tower condenser entrance or exit, and
b. directing the said nitrogen vapor product to a crude neon tower and utilizing a liquid bottom stream from the crude neon tower, after partial reduction in pressure to a pressure substantially higher than the low-pressure tower pressure to provide condensing refrigeration in the crude neon tower, and
c. directing the nitrogen vapor from the crude neon tower condenser cold or evaporating side to continue to a heat exchanger to become nitrogen product, without any connection to the double tower high pressure or low pressure tower and
d. removing a crude neon product from the uncondensed vapor at the top of the crude neon tower or at the exit of the crude neon tower condenser.

2. The process of claim number 1 wherein the crude neon product from a first neon recovery tower is directed to a second neon purification tower utilizing nitrogen-rich liquid evaporating at a lower pressure and temperature than the evaporating nitrogen in the first crude neon tower, to produce a higher purity crude neon product.

3. The process of claim number 2 wherein the crude neon product from a second neon recovery tower is directed to a third purification tower utilizing nitrogen-rich liquid evaporating at a lower pressure and temperature than the evaporating nitrogen in the second crude neon tower, to produce a higher purity crude neon product.
